(19) United States
(12) Patent Application Publication
(10) Pub. No.: US 2025/0118058 A1
(43) Pub. Date: Apr. 10, 2025

(54) Method for Evaluating a Training Data Set for a Machine Learning Model

(71) Applicant: Robert Bosch GmbH, Stuttgart (DE)

(72) Inventors: Andreas Steimer, Schoemberg (DE); Clint Sebastian, Stuttgart (DE); Jana Veser, Dannstadt-Schauernheim (DE); Laura Beggel, Stuttgart (DE); Thi Phuong Nhung Ngo, Karlsruhe (DE)

(21) Appl. No.: 18/899,246

(22) Filed: Sep. 27, 2024

(30) Foreign Application Priority Data
Oct. 4, 2023 (DE) 10 2023 209 685.4

(51) Int. Cl. G06V 10/776; G06V 10/75; G06V 10/774

(52) U.S. Cl. CPC G06V 10/776; G06V 10/751; G06V 10/774

(57) ABSTRACT

A method for evaluating a training data set for a machine learning model includes (i) providing sensor data, wherein a portion of the sensor data comprises a detection feature, (ii) generating synthetic data by another machine learning model based on the portion of the sensor data having the detection feature, (iii) determining a ratio between a fraction of synthetic data and a fraction of sensor data having the detection feature for the training data set, and (iv) evaluating the training data set by way of the determined ratio based on at least one metric. Also disclosed is a computer program, device, and a storage medium for this purpose.

This application claims priority under 35 U.S.C. § 119 to patent application no. DE 10 2023 209 685.4, filed on Oct. 4, 2023 in Germany, the disclosure of which is incorporated herein by reference in its entirety.

The disclosure relates to a method for evaluating a training data set for a machine learning model. The disclosure further relates to a computer program, a device, and a storage medium for this purpose.

### BACKGROUND

In the automated optical inspection of electronic components, such as SMD components, it may be challenging to capture images with production errors (NOK images) due to high production quality. This may make it difficult for machine learning model training to be reliable, robust, and of high quality. Also, the lack of availability of NOK images in suitable amount and variation may already present a challenge. Obtaining a representative data set with a sufficient number and variation of NOK images may consequently require significant time.

By enriching of the data (data augmentation), it is particularly possible to generate synthetic images and thereby reduce the time required to create a more diverse data set. This makes it possible in particular to train a more robust or higher quality machine learning model. Machine learning data sets or AI models can be artificially extended by generating new data points from the existing data. Furthermore, new variations may be created based on the existing data. This may be accomplished by way of techniques such as adding noise, rotating images, or changing texts to increase the amount and variety of available training data. There are various examples of quantitative metrics for evaluating the generated synthetic images with respect to a capability of the generating model to accurately measure the domain for which it was trained. For example, a Generative Adversarial Network (GAN) in the automotive industry preferably produces images of cars, which can be tested accordingly. Furthermore, an evaluation may be made with respect to an extent to which a domain space is covered. Further examples of metrics are the inception score, the Frechet inception distance, the likelihood score, and the maximum mean discrepancy.

Furthermore, there are various quantitative metrics for evaluating the synthetic images generated that measure the quality of the images. Most of these metrics are particularly designed for specific data sets such as MNIST, Celeb, and CIFAR data sets.

### SUMMARY

The subject-matter of the disclosure is a method, a computer program, a device, and a computer-readable storage medium having the features set forth below. Further features and details of the disclosure will also emerge from the description and the drawings. Features and details which are described in connection with the method according to the disclosure naturally also apply in connection with the computer program according to the disclosure, the device according to the disclosure, and the computer-readable storage medium according to the disclosure, and vice versa in each case, so that reference is always or can always be made to the individual aspects of the disclosure.

The subject-matter of the disclosure is in particular a method for evaluating a training data set for a machine learning model, comprising the following steps:
providing sensor data, wherein a portion of the sensor data comprises a detection feature,
generating synthetic data by another machine learning model based on the portion of the sensor data having the detection feature,
determining a ratio between a fraction of synthetic data and a fraction of sensor data having the detection feature for the training data set,
evaluating the training data set by way of the determined ratio based on at least one metric.
   Furthermore, in a further step, the training data set may be provided based on a result of the evaluation. The machine learning model is preferably trained on the basis of the training data set for detection and/or classification and/or segmentation of images. The sensor data may result from a capture of at least one sensor, wherein the at least one sensor may be, for example, a camera, a radar sensor, an ultrasonic sensor, a LiDAR, or a thermal imaging camera. The sensor data may comprise at least a single image. The portion of the sensor data having the detection feature may be at least one image comprising the detection feature. In the case of at least two images in the portion of the sensor data having the detection feature, preferably each image comprises the detection feature. It is conceivable that the detection feature is, for example, a defect such as a production error that is to be detected by the machine learning model to be trained by way of the training data set. The sensor data may further comprise sensor data without the detection feature. The further machine learning model may be trained to generate the synthetic data at first based on the portion of the sensor data having the detection feature. For example, the ratio may be an amount of individual images of the sensor data having the detection feature with respect to an amount of individual images of the synthetic data. The training data set further preferably comprises sensor data comprising no detection feature. In simplified terms, in particular the evaluation determines whether a sufficiently good training data set for training the machine learning model by way of the training data set is provided at the determined ratio, i.e., also using a fraction of synthetic data. For example, the result of evaluating the training data set may indicate whether the at least one metric exceeds a defined limit value. For example, the result of evaluating the training data set based on the at least one metric may indicate that the synthetic data is sufficiently similar to the sensor data having the detection feature or sufficiently suitable for training the machine learning model.

A further advantage may be achieved in the context of the disclosure if the method further comprises the steps of:
establishing at least two groups of data sets, wherein the establishing of the at least two groups of data sets is based on a respective different ratio between the synthetic data and the sensor data having the detection feature,
evaluating the at least two data set groups based on the at least one metric,
   The data set groups further preferably comprise a fraction of sensor data without the detection feature. Determining the ratio between the fraction of synthetic data and the fraction of sensor data having the detection feature for the training data set may be performed based on a result of evaluating the at least two data set groups. Thus, advantageously, different ratios between the synthetic data and the sensor data having the detection feature can be tested to determine an optimal ratio for the training data set. For example, it is conceivable that different ratios are optimal for different applications. Specifically, determining the ratio based on the result of evaluating the at least two groups of data sets indicates that the determined metrics of the at least two groups of data sets are compared in order to determine a highest quality group of data sets with respect to the at least one metric based on the comparison of the respective determined metrics.

It is further conceivable that the at least one metric is determined based on a comparison between the synthetic data and the sensor data having the detection feature, wherein the comparison is performed with respect to pixel values and/or features of the synthetic data and the sensor data having the detection feature. A similarity between the synthetic data and the sensor data having the detection feature can thereby advantageously be determined, which is reflected in the at least one metric. For example, a convolutional neural network may be used and/or a histogram comparison and/or feature extraction may be performed.

Preferably, the disclosure may provide that the method further comprises the following steps:
providing a reference data set group, wherein the reference data set group comprises the sensor data and no synthetic data,
initiating a training of a reference machine learning model based on the reference data set group,
initiating a training of a respective group machine learning model based on a respective one of the at least two groups of data sets,
   The at least one metric or another of the at least one metric may be determined based on comparing a predictive performance of the respective trained group machine learning models with a predictive performance of the reference machine learning model. For example, the reference data set may comprise only the sensor data, which, in simplified terms, may correspond to real-world sensor data from a measurement of at least one sensor. Advantageously, the different ratios between the synthetic data and the sensor data having the detection feature can thus be evaluated relative to an actual application by a machine learning model trained at a particular ratio. For example, the predictive performance may be a quantity of false positive and/or false negative detections of the detection feature by a particular group machine learning model and the reference machine learning model.

Furthermore, it is conceivable that a quantity of data set groups is established, wherein a respective data set comprises a fraction of (i−1)*x % sensor data having the detection feature, wherein {i|i∈N, 1≤i≤n}. Advantageously taking into account a computational effort, an individual amount of data set groups and a fraction of sensor data having the detection feature can thereby be determined and may be specific for a particular application, for example. For example, the variable may correspond to x a value of 5 or 10.

It may be advantageous if, within the scope of the disclosure, the further machine learning model is a generative machine learning model, for example a Generative Adversarial Network. A generative machine learning model is in particular a type of machine learning model that aims to generate new data points, i.e., in particular, the synthetic data, that are similar to the same statistical characteristics of training data of the generative machine learning model. Instead of merely predicting or classifying data, a generative machine learning model may capture an underlying probability distribution of data and generate new, previously unseen data points therefrom, i.e., in particular, the synthetic data. Generative adversarial networks (GANs) in particular include two networks: a generator and a discriminator. The generator preferably attempts to imitate real data by generating synthetic data, while the discriminator, in particular, distinguishes between real and synthetic data generated by the generator. Said adversarial process can advantageously continuously improve both networks. In addition to the generative adversarial network, for example, a variational autoencoder, diffusion models, or flow-based approaches are also conceivable.

Further, it is conceivable that the detection feature is a production error of a surface-mounted component and/or of a printed circuit board for surface-mounted components, and the machine learning model is trained on the basis of the provided training data set for detection of production errors in manufacturing, in particular surface mount technology manufacturing. The detection feature can thus be, for example, a defective or non-existent soldering joint or an incorrect surface-mounted component. Also, the detection feature may be, for example, a damaged or misaligned lead of the printed circuit board or a scratch on the printed circuit board. The method can be particularly advantageous in the field of manufacturing, in particular surface mount technology manufacturing, since production errors rarely occur in this case, for example. Using the synthetic data, a ratio can be determined by way of which an equally good or even better detection of the detection features, i.e., in particular the production error, is possible by way of the machine learning model.

The sensor data may, for example, comprise image data resulting from recording with a camera sensor. In this case, an environment can be represented by the values of image points, preferably pixels, of the image data. By way of classification and preferably image classification by the machine learning model to be trained based on said values, objects of the environment, or the detection feature, can also be detected. The classification and image classification can also be provided in the form of semantic segmentation (i.e., pixel-by-pixel or area-by-area classification) and/or object detection. The image data can be images of a radar sensor and/or an ultrasonic sensor and/or a LiDAR sensor and/or a thermal imaging camera for example. Accordingly, the images can also be embodied as radar images and/or ultrasonic images and/or thermal images and/or lidar images.

Another object of the disclosure is a computer program, in particular a computer program product, comprising instructions which, when the computer program is executed by a computer, cause the computer to carry out the method according to the disclosure. The computer program according to the disclosure thus brings with it the same advantages as have been described in detail with reference to a method according to the disclosure.

The disclosure also relates to a device for data processing which is configured to carry out the method according to the disclosure. The device can be a computer, for example, that executes the computer program according to the disclosure. The computer can comprise at least one processor for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or instructions that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

In addition, the method according to the disclosure can also be designed as a computer-implemented method.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination. Shown are:

FIG. 1 a schematic visualization of a method, a device, a storage medium, and a computer program according to exemplary embodiments of the disclosure,

FIG. 2 a schematic illustration of a surface-mounted component and a printed circuit board for surface-mounted components in accordance with exemplary embodiments of the disclosure.

### DETAILED DESCRIPTION

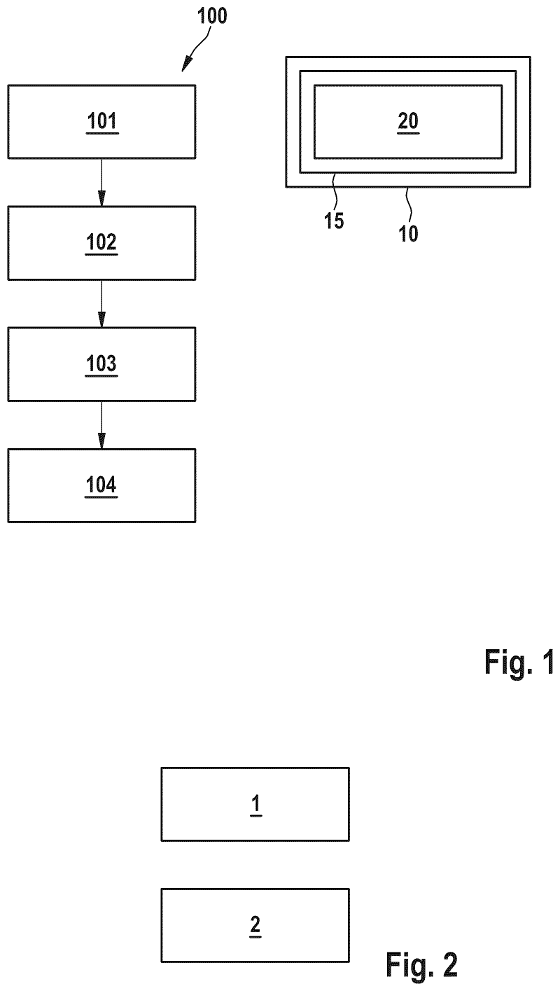

FIG. 1 schematically illustrates a method 100, a device 10, a storage medium 15, and a computer program 20 according to exemplary embodiments of the disclosure.

In particular, FIG. 1 shows a method 100 for evaluating a training data set for a machine learning model according to exemplary embodiments of the disclosure. In a first step 101, sensor data is provided, wherein a portion of the sensor data comprises a detection feature. In a second step 102, synthetic data is generated based on the portion of the sensor data having the detection feature by a further machine learning model. In a third step 103, a ratio is determined between a fraction of synthetic data and a fraction of sensor data having the detection feature for the training data set. In a fourth step 104, the training data set is evaluated by way of the determined ratio based on at least one metric. In a fifth step (not shown), the training data set may be provided based on a result of the evaluation.

FIG. 2 shows a schematic illustration of a surface mounted component 1 and a printed circuit board 2 for surface mounted components 1 according to exemplary embodiments of the disclosure.

According to exemplary embodiments of the disclosure, in particular for Automated Optical Inspection (AOI), more than just the quality of the synthetic image can be evaluated. The synthetic images can be validated in connection with an application, i.e., in particular in the context of an application of a machine learning model.

In the following, a rating scheme for a usability of synthetic images is described, in particular in connection with AOI applications, according to exemplary embodiments of the disclosure. A detection or prediction performance regarding an application in which the synthetic images are applied may be given more weight than a pure image quality of the synthetic images.

A machine learning model, in particular a neural network, according to exemplary embodiments of the disclosure is preferably capable of meeting required performance metrics for very different optical inspection applications, such as an application of optical surface mount technology (SMT) inspection. The machine learning model may still be general enough to maintain this performance even in manufacturing, where a variety of electrical components and failure modes can be observed.

The evaluation scheme according to exemplary embodiments can be divided into two steps, wherein in a first step the synthetic data is prepared and in a second step the actual evaluation of the synthetic data is carried out. To prepare the synthetic data for evaluation, the original data set may be split into two parts: the first part preferably comprises some randomly selected sensor data having a detection feature (in the following figure description: NOK images) and the second part comprises the remainder (in the following figure description: OK images). The randomly selected NOK images may be used as input for training a machine learning model, particularly a generative model, for example a Generative Adversarial Network (GAN). Once the machine learning model is trained, it can be used to generate a large quantity, for example, more than 100 times the original NOK images, of synthetic data (in the following figure description: synthetic NOK images). The generated synthetic NOK images are preferably used along with the remainder of the original data set in a next evaluation step.

In the evaluation step, a fixed quantity of original OK images and original NOK images may be retained as a reference data set group (holdout test set). The remainder can be used to create different groups of data sets {1, . . . , {11}} so that each group of data sets includes a fixed quantity of original OK images, a fixed quantity of synthetic NOK images, and a quantity of (−1)*x percent, particularly (−1)*10 percent, original NOK images. Said data set groups may be used to train {1, . . . , {11}} group machine learning models. The holdout test set may be used to evaluate a predictive performance based on at least one metric, such as an area under an ROC curve, a false positive rate, and/or escape rates of said models. In particular, the escape rate is measured by dividing a quantity of false-negative results by a total quantity of predictions. Advantageously, a ratio between synthetic NOK images and original NOK images for a training data set can now be determined, which can also achieve or exceed a predictive performance of a base model using only original NOK images for training, using a lower quantity of original NOK images, and instead using synthetic NOK images.

The above explanation of the embodiments describes the present disclosure solely within the scope of examples. Of course, individual features of the embodiments can be freely combined with one another, if technically feasible, without leaving the scope of the present disclosure.

What is claimed is:

1. A method for evaluating a training data set for a machine learning model, comprising:
providing sensor data, wherein a portion of the sensor data comprises a detection feature;
generating synthetic data by another machine learning model based on the portion of the sensor data having the detection feature;
determining a ratio between a fraction of synthetic data and a fraction of sensor data having the detection feature for the training data set; and
evaluating the training data set by way of the determined ratio based on at least one metric.

2. The method according to claim 1, further comprising:
establishing at least two groups of data sets, wherein the establishing of the at least two groups of data sets is based on a respective different ratio between the synthetic data and the sensor data having the detection feature; and
evaluating the at least two data set groups based on the at least one metric, wherein determining the ratio between the fraction of synthetic data and the fraction of sensor data having the detection feature for the training data set is performed based on a result of evaluating the at least two data set groups.

3. The method according to claim 1 wherein:
the at least one metric is determined based on a comparison between the synthetic data and the sensor data having the detection feature, and
the comparison is made with respect to pixel values and/or features of the synthetic data and the sensor data having the detection feature.

4. The method of claim 1, further comprising:
providing a reference data set group, wherein the reference data set group comprises the sensor data and no synthetic data;
initiating a training of a reference machine learning model based on the reference data set group; and
initiating a training of a respective group machine learning model based on a respective one of the at least two groups of data sets,
wherein the at least one metric is determined based on comparing a predictive performance of the respective trained group machine learning models with a predictive performance of the reference machine learning model.

5. The method according to claim 2, wherein:
a quantity of groups of n data sets is established, and
a respective group of data sets comprises a fraction of (i−1)*x % sensor data having the detection feature, and
{i|i∈N, 1≤i≤n}.

6. The method according to claim 1, wherein the further machine learning model is a generative machine learning model.

7. The method according to claim 1, wherein:
the detection feature is a production error of a surface mounted component and/or of a printed circuit board for surface mounted components, and
the machine learning model is trained on the basis of the provided training data set for detecting production errors in manufacturing.

8. A computer program comprising instructions for causing the computer to carry out the method according to claim 1 when the computer program is executed by a computer.

9. A device for data processing which is configured to carry out the method according to claim 1.

10. A computer-readable storage medium, comprising instructions which, when executed by a computer, cause it to carry out the steps of the method according to claim 1.
